(19) United States
(12) Patent Application Publication
(10) Pub. No.: US 2017/0117066 A1
(43) Pub. Date: Apr. 27, 2017

(54) METAL OXYGEN FUSION REACTOR

(71) Applicant: K-Orbital LLC, Parker, CO (US)

(72) Inventors: Kenneth N. Swartz, Lakewood, CO (US); Gary Rodriguez, Parker, CO (US); Roger X. Lenard, Edgewood, NM (US); David G Schrunk, Poway, CO (US)

(21) Appl. No.: 15/334,239

(22) Filed: Oct. 25, 2016

Related U.S. Application Data
(60) Provisional application No. 62/246,396, filed on Oct. 26, 2015.

(51) Int. Cl. G21G 1/02; G21B 3/00

(52) U.S. Cl. CPC G21G 1/02; G21B 3/00

(57) ABSTRACT

An exothermic fusion reactor is described that uses metal-oxygen transmutation. The process comprises a negatively-charged environment; a moderator comprising at least one noble gas; a metal, including isotopes of hydrogen; and a facilitator comprising at least one element selected from the group consisting of oxygen, carbon, nitrogen, fluorine, phosphorus, sulfur, chlorine, selenium, bromine, iodine, or combinations thereof.

The present invention claims priority to U.S. provisional application No. 62/246,396.

### FIELD OF THE INVENTION

The invention relates to an article and method for producing select atomic species and energy using metal-oxygen transmutation.

### BACKGROUND OF THE INVENTION

Nuclear reactions can occur via either fusion or fission. A widespread belief is that fusion only occurs at extreme temperatures. The fusion process above iron is endothermic because less energy is produced by the reaction than is needed to maintain the temperature and supporting magnetic fields. Fission can occur at low temperatures and pressures, and can be highly exothermic. Unfortunately, it evolves highly radioactive species that can have half-lives of thousands of years. The nuclei needed for fission are also a limited resource.

Nuclear transmutation at low temperatures and varying pressures without the evolution of radioactive species would be a boon to energy generation. Such a process could be an inexpensive source of nearly limitless energy and atomic species.

### SUMMARY OF THE INVENTION

The object of this invention is to provide an article and method for producing nuclear transmutation at low temperatures and varying pressures that are scalable, portable and throttleable. The invention takes advantage of an effect that occurs between metals and facilitating elements under elevated negative charge, which induces a substantial reduction of the Relative-Rate-of-Change (RRoC), reducing the Coulomb Barrier to generate fusion. Metal can include isotopes of hydrogen and compounds of metals such as, but not limited to, metal oxides.

The process includes providing:
a. a negatively-charged environment;
b. a moderator comprising at least one noble gas;
c. a metal, including isotopes of hydrogen; and
d. a facilitator comprising at least one element selected from the group consisting of oxygen, carbon, nitrogen, fluorine, phosphorus, sulfur, chlorine, selenium, bromine, iodine, or combinations thereof.

A facilitator proximate, chemically or physically, to a metal, e.g., a metal oxide such as heavy water (deuterium oxide) can sustain the process at moderate voltage levels within the negatively-charged environment, which induces the RRoC effect.

The article capable of the fusion process can also be interlaced with a nuclear furnace. A concurrent processes involving the article and the nuclear furnace can fuse or fission intermediate products, neutralize or mitigate toxic chemicals and radioactive materials, while creating neutral, and often valuable industrial components, such as metals and unstable daughter isotopes.

In an embodiment, the RRoC may also be directly modulated in fissionable isotopes, so that an article comprises a positive plate separated from a negative plate by a dielectric layer. The negative plate repels electrons from the positive plate. In embodiments, the positive plate comprises a metal such as, for example, depleted uranium. The negative plate comprises a second metal, such as for example steel. Finally, the dielectric layer can comprise an organic polymer film, such as for example, a polyimide, one variant which is sold under the tradename Kapton®. This configuration can accelerate isotope decay rates.

Reversing the polarity of the applied direct current can depress the decay rates, thereby extending the effective half-life of radioactive isotopes.

The article and method can produce energy but can also produce isotopes that can be used in fields including medicine, particularly at the in-situ point-of-use.

### BRIEF DESCRIPTION OF THE DRAWING

FIG. 1 shows a pathway for the process of metal-oxygen transmutation.

FIG. 2 shows a transmutation reactor of the present invention.

FIG. 3 shows an article of the invention comprising a capacitor.

FIG. 4 shows the polarity of the article of FIG. 2.

### DETAILED DESCRIPTION OF THE INVENTION

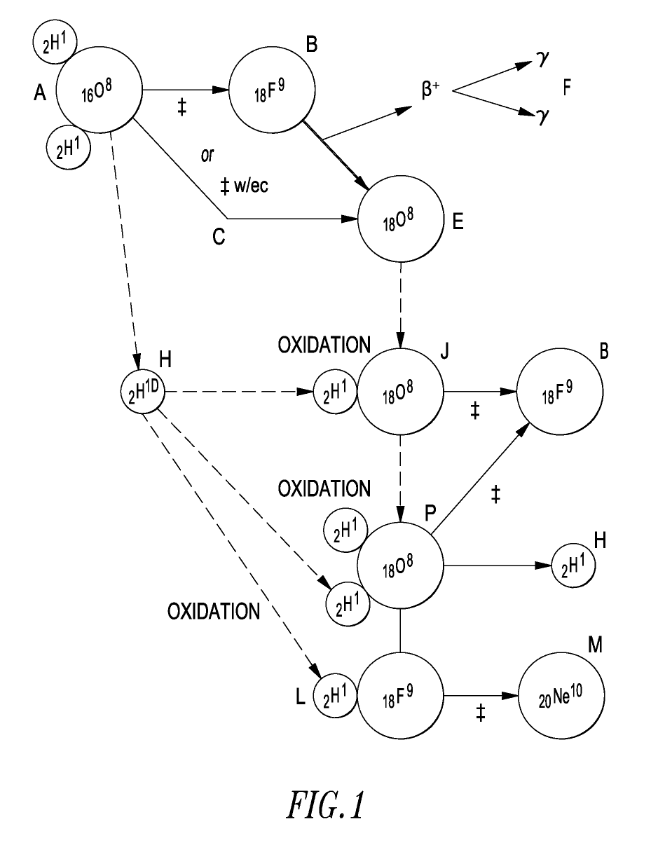

FIG. 1 describes an embodiment of the present method, known as the metal-oxygen (MOXY) fusion process. The MOXY fusion process includes (a) a negatively charged environment, (b) a moderator comprising at least one noble gas, (c) a metal, including isotopes of hydrogen, and (d) a facilitator selected from the group consisting of oxygen, carbon, nitrogen, fluorine, phosphorus, sulfur, chlorine, selenium, bromine, iodine, or combinations thereof.

Some representative examples include:

⁷₃Li+¹⁶₈O→²³₁₁Na

⁹₄Be+¹⁶₈O→²⁵₁₂Mg

¹¹₅B+¹⁶₈O→²⁷₁₃Al

¹²₆C+¹⁶₈O→²⁸₁₄Si

²³₁₁Na+¹⁶₈O→³⁹₁₉K

²⁴₁₂Mg+¹⁶₈O→⁴⁰₂₀Ca

⁴⁰₂₀Ca+¹⁶₈O→⁵⁶₂₈Fe

⁴⁷Ti+¹⁶O→⁶³Zn→⁵¹Cr*ec→⁵¹V

⁵⁰Ti+¹⁶O→⁶⁶Zn

⁵⁰Ti+¹⁶O→⁶⁶Zn⁶²Ni+α

⁵⁰Ti+¹⁶O→⁶⁶Zn→⁵⁸Fe+α

⁵⁰Ti+¹⁶O→⁶⁶Zn→⁵⁴Cr+3α

⁸⁷₃₈Sr+¹⁶₈O→¹⁰⁴₄₆Pd

⁸⁷₃₈Sr+¹⁶₈O→¹⁰³₄₆Pd+α→¹⁰¹₄₄Ru

⁹²₄₀Zr+¹⁶₈O→¹⁰⁸₄₈Cd+α→¹⁰⁴₄₆Pd

⁹¹₄₁Zr+¹⁶₈O→¹⁰⁷₄₈Cd+α→¹⁰³₄₆Pd+ec→¹⁰³₄₅Rh

Some of the immediate transmutation products are unstable, and quickly decay into other products, balancing the equation with emissions of gamma, X-ray, electron capture, β⁺ (positron), α, or other radiation.

Nuclear synthesis is augmented by the presence of noble gasses, particularly argon. The noble gases, (₂Helium, ₁₀Neon, ₁₈Argon, ₃₆Krypton, ₅₄Xenon, and ₈₆Radon), would be candidates for moderators. Similar to a catalyst, the process does not occur or occurs rarely without the presence of a significant volume of noble gas in the reaction chamber to serve as a thermal moderator or physical scaffolding and the noble gas is not consumed by the process.

FIG. 1 shows a pathway for a MOXY reaction. The process begins at [A] with a metal oxide, in this embodiment deuterium oxide a.k.a. heavy water. Deuterium works well because it has a 1:1 ratio of neutrons to protons. Ordinary water may include sufficient deuterium to facilitate the transmutation. Distilled water is generally deficient of deuterium. An excess of protons in an atomic nucleus [Fluorine-18, FIG. 1, Step B] will invoke an electron capture from an interior electron shell. It is to be understood that the metal oxide is not limited to deuterium oxide; however, deuterium is plentiful and non-toxic.

Paths [A→C] and [A→E] yield a spare deuterium atom from the original heavy water molecule [A]. The spare deuterium atom with the availability of oxygen-18 in a high-voltage environment can be expected to oxidize or combust. For this process, high voltage means greater than about 10 volts. The majority of these events will result in hydroxyl ions with a single deuterium atom and a single oxygen-18 atom. The availability of deuterium and hydroxyl ions could reconstitute heavy water molecules. In the negatively charged environment, the hydroxyl ion can quickly undergo the fusion step, [A→B], in which fluorine-18, a radioactive isotope, is produced. This result is transitory and either reduces immediately into an atom of oxygen-18 through electron capture [A→C] or the fluorine-18 atom decays through positron emission with a half-life of 110 minutes [A→E]. The positron and an electron mutually annihilate to yield a pair of 0.511 MeV Gamma Photons [F]. Conveniently, radioactive fluorine-18 isotopes have research and medicinal purposes.

Alternative paths anticipate the remaining deuterium atom would then react with fluorine, and oxygen atoms, [L]. Another possibility is the fusion of the HF molecule into a terminal neon-20 atom [M]. Conveniently, the expected β+ (positron) collides with an electron, which, by mutual annihilation, yields a pair of gamma photons.

The process of the invention contravenes the standard fusion model, which requires high energy plasmas. Plasmas are often comprised of atoms from which their electrons have been stripped away. The MOXY process does not strip away, i.e., ionize, electrons from the intended fusion source atoms. Rather the relatively lower-energy plasma of the MOXY process adds a significant population of electrons to the immediate environs of the objective fusion source atoms.

A convenient and straightforward method for creating of an electron-rich environment is to provide an open spark gap, with a continuous spark emission, through which the metal, facilitator, and moderator gas can flow. A gap of 0.25 inch (6.4 mm) will conveniently support a 5 kV spark. Voltages above 10 kV can produce X-rays, which may be undesirable when testing for fusion radiation signatures.

The moderator in the process establishes a “thermal/pressure buffer” that enables the persistence of interacting molecules and extends bonding and fusing opportunities. Without intending to be legally bound, moderators may serve a spatial (geometric) role, forming a “scaffolding” that aligns, and orients receptors, and inceptors to a self-organizing result. These roles are further considered to be effective at the scales of both chemical and nuclear phenomena.

Prior research suggests that “relative time” accelerates when electrons are stripped from a metal. Fusion is a slower-in-time, lower energy process. Slower rate, low RRoC fusion generally leads to neutron-deficient atoms, with greatly-reduced Coulomb Barriers. The probability of (3+(positron) decay is sometimes neutralized by annihilation with an electron, generating a pair of gamma photons.

The facilitator enhances the probability of MOXY fusion. The facilitator can be highly electronegative ions in an electron-rich plasma, and will include at least one element selected from the group consisting of oxygen, carbon, nitrogen, fluorine, phosphorus, sulfur, chlorine, selenium, bromine, iodine, or combinations thereof. For example, a metal oxide, or metal-facilitator compound, can achieve MOXY fusion. A chemical bond, however, is not required for achieving MOXY fusion, yet chemical proximity appears to enhance fusion, or the probability of fusion. Physical proximity of the metal and facilitator also appears to enhance MOXY fusion.

The process is viable at ambient atmospheres of standard temperature and pressure. The process is expected to be enhanced under elevated pressure or temperatures, and there are apparent examples of operation at lower pressures.

The choice of electrodes will determine the characteristics of potential daughter products outside of the intended production stream. For example, an embodiment of MOXY fusion may occur at an iron anode. Alternatively, exotic electrodes of certain atomic families can produce radioactive gases. Examples of a emitters and are shown below:

¹⁰⁶Pd+¹⁶O→¹²²Xe and ¹⁹⁵Pt+¹⁶O→²¹¹Rn

A summary of the MOXY process includes:
a. the presence of leptons, usually electrons, in a high ratio to baryons, usually protons and neutrons,
b. the presence of a negatively-charged environment, often a plasma, that retards the local Relative-Rate-of-Change (RRoC),
c. a highly positive voltage will accelerate the decay rate of unstable isotopes, such as U-235, and can be used to accelerate its depletion, speeding up the decay rate of the U-235 isotope,
d. conversely, a highly negative voltage can be used to maintain, and extend the half-life of an unstable isotope,
e. the presence of one or more moderator gasses, e.g., noble gas,
f. the presence of a metal, including isotopes hydrogen,
g. the presence of a high electronegativity facilitators,
h. the use of a shielding material, or a stack of shielding laminations that render the MOXY device safe to biologicals during operation,
i. the use of material to alter a high-energy flux of gamma and X-Ray into a flux of low-energy thermal energy, e.g., visible and infrared light.

### Example 1

FIG. 1 is described as follows: Steps A-B: fusion of Deuterium with adjacent Oxygen atom, generating a Fluorine-18 isotope.

Steps B-C: Fluorine-18 generates Oxygen-18 through Electron Capture.

Steps B-E: Fluorine decay generating Oxygen-18, and F, emitting a pair of gamma photons through positron-electron annihilation.

Steps A-H: Fusion of Deuterium with adjacent Oxygen atom liberates an excess Deuterium atom.

Steps E-J/H-J: Free Deuterium (Heavy Hydrogen) combusts with free Oxygen, forming an Hydroxyl molecule (OH) ignited by the electric spark.

Steps H-L/B-L: Free Deuterium (Heavy Hydrogen) combusts with free Fluorine, forming an FH molecule ignited by the electric spark.

Steps H-P/J-P: Hydroxyl (OH) molecules may further combust with free Deuterium or Hydrogen to form H₂O (D₂O), ignited by electric spark.

Steps L-M: Fusion of Deuterium/Fluorine or Oxygen to form Neon.

For example, and referencing FIG. 1, signature characteristics of Deuterium-Oxygen fusion would include:

F: Gamma and X-Ray Photons

B: Any isotope of Fluorine

C, E: O-18 atoms

H: Single Deuterium atoms, or D₂ molecules

Low probability effects cannot be ruled out entirely, and include the following, in the order of considered probability:
a. Second-tier electron capture, yielding X-Ray, or 1.655 MeV gamma photons,
b. Alpha particle decay, yielding X-Ray, or gamma photons,
c. Positron decay, (not to be confused with Positron/Electron annihilation),
d. Beta decay.

Multiple pathways can lead to transmutations, i.e., the production of elemental species that had not been present prior to the conduct of an experiment. Medical providers can require short half-life species. The method can be used to produce these species, in-situ, and reduce the costs to patients and healthcare providers. For example, the method can be used to deliberately synthesize isotopes of fluorine, F-18, and oxygen, O-18.

In practice, the electrodes do not contact the water reservoir because they would reduce the effectiveness of the electric arc (spark). Also, the heavy water may optionally be heated to produce a higher content of vapor than would otherwise develop,

### Example 2

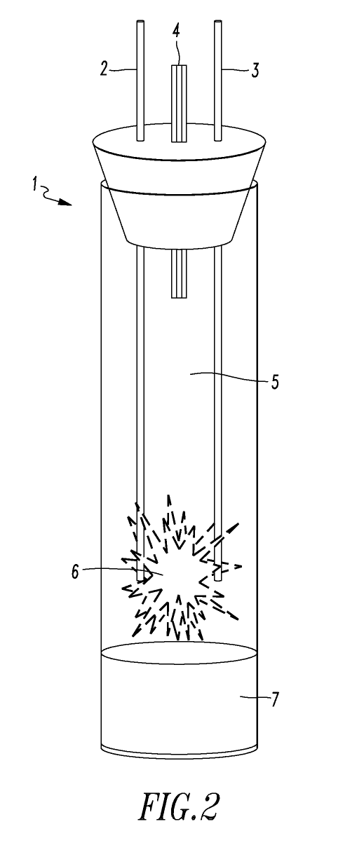

FIG. 2 shows a reaction vessel [1], a first electrode [2], a second electrode [3], a vent [4], an atmosphere [5] comprising deuterium and argon, a spark gap [6] capable of producing 5,000 volts, and a deuterium reservoir [7].

### Example 3

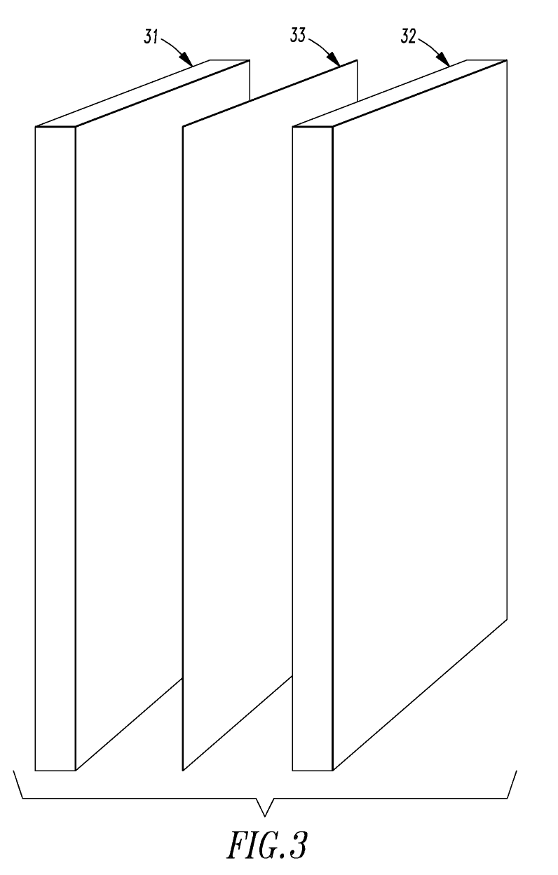

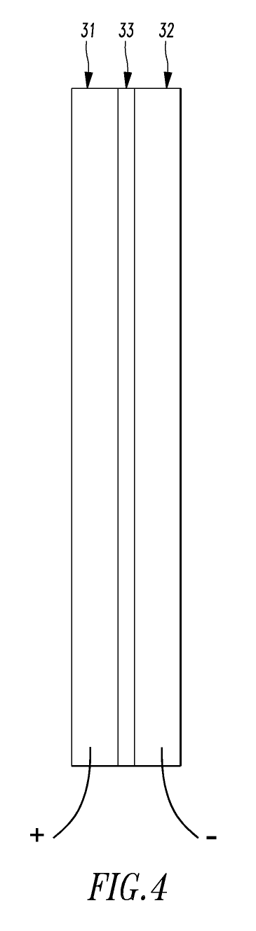

A process that manipulates the conjectured Relative-Rate-of-Change effect to either accelerate or retard apparent time, and indirectly, radioactive decay rates. FIGS. 3 and 4: The method can accelerate and decelerate the radioactive decay of unstable uranium metal (U-235) by fission or radioactive decay. Existing applications of uranium metal, that is, U-238, include X-ray shielding, munitions, and ballast.

In FIG. 4, a direct application of induced Relative-Rate-of-Change (RRoC) uses capacitive plates to deplete electrons from a plate of depleted uranium, which contains less than 2% of U-235. This level of unstable (radioactive) U-235 isotope is toxic for bio-organisms. Accelerating the decay of U-235 will increase the value of safety of the remaining, more stable U-238, which is still radioactive but with a half-life of 4.4 billion years.

As shown in FIGS. 3 and 4, a capacitor comprises a positive plate 31 and a negative plate 32 separated by a dielectric layer 33. Electrons are extracted from the positive plate 31, which may comprise depleted uranium, that is U-238 with less than about 2% U-235. The dielectric layer 33 can comprise any material having a high dielectric constant. The dielectric layer can comprise a polymer. In embodiments, the polymer comprises a polyimide such as Kapton®. The negative plate 32 can comprise any suitable metal such as, for example, steel. A metal with high electron density is preferred.

When a high direct-current voltage is applied to the device, observing a correct polarity, the positive plate 31 becomes positive and the negative plate 32 becomes negative. See FIG. 3. The accumulation of electrons on the negative plate 32 will repel electrons from the positive plate 31, inducing a strong positive charge. A free-neutron rich environment enhances this effect.

What is believed to be the best modes of the invention have been described above. However, it will be apparent to those skilled in the art that numerous variations of the type described could be made to the present invention without departing from the spirit of the invention. The scope of the present invention is defined by the broad general meaning of the terms in which the claims are expressed.

1. A process for producing nuclear transmutation at low temperature includes providing:
a) a negatively-charged environment sufficient to induce the Relative-Rate-of-Change effect;
b) a moderator comprising at least one noble gas;
c) a metal; and
d) a facilitator in an electron-rich environment proximate to the metal and comprising at least one high electronegativity element.

2. The process of claim 1, wherein an article comprising a positive plate separated from a negative plate by a dielectric layer produces the negatively-charged environment, wherein the negative plate repels electrons from the positive plate.

3. The process of claim 2, wherein the positive plate comprises a first metal.

4. The process of claim 3, wherein the first metal comprises depleted uranium.

5. The process of claim 2, wherein the negative plate comprises a second metal.

6. The process of claim 5, wherein the second metal comprises steel.

7. The process of claim 2, wherein the dielectric layer comprises an organic polymer film.

8. The process of claim 7, wherein the organic polymer film comprises a polyimide.

9. The process of claim 1, wherein producing the negatively-charged environment comprises applying a direct current.

10. The process of claim 9, wherein the direct current is at least 10 volts.

11. The process of claim 9, wherein the direct current can be reversed, whereby decay rates are depressed and half-lives of radioactive isotopes are extended.

12. The process of claim 1, wherein the high electronegativity element is selected from the group consisting of oxygen, carbon, nitrogen, fluorine, phosphorus, sulfur, chlorine, selenium, bromine, iodine, or similar, or combinations thereof.

13. The process of claim 1, wherein producing the electron-rich environment comprises a spark gap with a continuous spark emission through which flows the metal, facilitator, and moderator.

14. The process of claim 13, wherein the spark gap comprises an opening of at least 6.4 mm, whereby a spark of at least 5 kV is produced.

15. The process of claim 1, wherein altering the process includes adjusting levels of at least one factor selected from the group consisting of the negatively-charged environment, the moderator, the metal, and the facilitator.

16. The process of claim 15, wherein altering the process comprises at least one alteration selected from the group consisting of scaling the process, throttling the process, or mobilizing the process.

17. The process of claim 1, wherein interlacing with fission events in a nuclear furnace destroys toxic materials.

18. The process of claim 1, wherein interlacing with fission events in a nuclear furnace produces useful components.

19. A process for Relative-Rate-of-Change Modulation includes:
a) suppressing isotope fission using a negatively-charged environment;
b) enhancing isotope fission with a positively-charged environment;
c) capture of emissions as electric current.

20. The process of claim 20, wherein the capture of emissions as electric currents comprises plates and laminates;
